(19) United States
(12) Patent Application Publication
(10) Pub. No.: US 2024/0173981 A1
(43) Pub. Date: May 30, 2024

(54) Cleaning assembly for a drop-on-demand print head

(71) Applicant: Atlantic Zeiser GmbH, Emmingen-Liptingen (DE)

(72) Inventors: Markus WENGER, Emmingen-Liptingen (DE); Steffen MUFFLER, Emmingen-Liptingen (DE); Michael DREXLER, Emmingen-Liptingen (DE); Daniel ORTIZ, Emmingen-Liptingen (DE); Felix LIEBL, Emmingen-Liptingen (DE)

(21) Appl. No.: 18/522,632

(22) Filed: Nov. 29, 2023

(30) Foreign Application Priority Data
Nov. 29, 2022 (IT) 102022000024624
Nov. 29, 2022 (IT) 102022000024627

(51) Int. Cl. B41J 2/165

(52) U.S. Cl. CPC B41J 2/16552; B41J 2/16532; B41J 2/16538; B41J 2002/16558

(57) ABSTRACT

A cleaning assembly for a DOD print head including a main body, a suction hole provided near an outer surface of the main body, the outer surface facing a nozzle plate and the suction hole facing the plurality of nozzles, and a moving mechanism, the outer surface including a contact cleaning element surrounding an outer perimeter the suction hole, an area of a region surface delimited by the contact cleaning element being smaller than an area of the outer surface, the moving mechanism bringing the contact cleaning element in contact with the nozzle plate and moving the main body relative to the print head body along the second direction.

### CROSS-REFERENCE TO RELATED APPLICATIONS

This patent application claims the benefit and priority of Italian Patent Application No. 102022000024627, filed on Nov. 29, 2022, and Italian Patent Application No. 102022000024624, filed on Nov. 29, 2022, the disclosures of which are incorporated by referenced herein in their entirety as part of the present application.

### TECHNICAL FIELD

The present disclosure relates to the technical field of cleaning a drop-on-demand print head, in particular a print head intended to be used in a card processing system and/or a card processing method. More particularly, the present invention relates to a cleaning assembly for such a drop-on-demand print head, a cleaning method involving such a cleaning assembly and a cleaning method of a drop-on-demand print head.

### BACKGROUND

It is known, for example from document US 2019/0061356, a card processing system in which a nozzle of a print head is cleaned. More particularly, the device disclosed in this document includes a cleaning mechanism cleaning the nozzle plate of a drop-on-demand print head without the cleaning mechanism physically contacting the nozzle plate.

Although such a system is considered generally satisfactory, an undesirable amount of particles in liquid or solid form may remain in the nozzles of the print head sometimes.

In particular, in a cleaning mechanism including a conventional vacuum port, a polymerization of ink sucked via the vacuum port sometimes occurs in the vacuum port, resulting in a clogging of the vacuum port or of the vacuum system associated with the port. This results in a decrease of efficiency of the cleaning of the print head, which affects the printing quality by the printing system or the processing system including such a cleaning mechanism.

There is therefore a need for a device adapted for cleaning a drop-on-demand print head, which increases efficiency of the cleaning of the nozzles of the print head.

### SUMMARY

According to a first aspect of the present disclosure, there is provided a cleaning assembly for a drop-on-demand print head having a print head body, a nozzle plate and a plurality of nozzles distributed on the nozzle plate. The cleaning assembly may include a main body. The cleaning assembly may include at least one suction hole which may be provided near an outer surface of the main body. The main body may be configured so that, when the cleaning assembly is used for cleaning a drop-on-demand print head, the outer surface is able to face at least a part of the nozzle plate. The main body may be further configured so that, when the cleaning assembly is used for cleaning a drop-on-demand print head, the suction hole is able to face at least one of the plurality of nozzles. The cleaning assembly may include a suction passage fluidly communicating with the suction hole. The cleaning assembly may include a moving mechanism. The moving mechanism may be for moving the main body with respect to the print head body along a first direction perpendicular to a plane of the nozzle plate. The moving mechanism may be for moving the main body with respect to the print head body along a second direction parallel to the plane of the nozzle plate.

The cleaning assembly may include a cleaning fluid passage. The cleaning fluid passage may communicate with the suction hole. The cleaning assembly may also include a spraying means. The spraying means may fluidly communicate with the cleaning fluid passage so that it may be able to spray a cleaning fluid inside the suction hole towards an outside of the main body.

The outer surface of the main body may include a contact cleaning element. The contact cleaning element may surround at least in part an outer perimeter of the suction hole. An area of a region surface delimited by the contact cleaning element may be smaller than an area of the outer surface.

The moving mechanism may be configured to bring the contact cleaning element in contact with the nozzle plate. The moving element may be further configured so that, when the contact cleaning element contacts the nozzle plate, it may move the main body relative to the print head body along the second direction.

Such a configuration allows cleaning by contact the print head in combination with a suction hole, wherein the contact cleaning element is provided relatively close to the suction hole and the cleaning fluid is sprayed to avoid damaging the nozzle plate during the cleaning process. By doing so, the contact cleaning element closely cooperates with the suction hole and carefully wipe the nozzle plate which results in a more efficient cleaning of the nozzles.

The contact cleaning element may be a sealing element, which may be configured to seal a volume fluidly communicating with the suction hole when the contact cleaning element contacts the nozzle plate.

By virtue of such a sealing element, it may be performed a sealing of the volume delimited by the contact cleaning element, which, in combination with the area delimited by the sealing element being smaller than the area of the outer surface, allows further increasing efficiency of the cleaning process by the suction hole.

Therefore, the present invention provides a contact cleaning element implementing a wiping action for cleaning the nozzle plate, wherein the wiping action is further assisted by a vacuum sealing action implemented by the same contact cleaning element.

A synergistic effect is therefore obtained by using contact cleaning element performing both the action of sealing and the action of wiping. In other words, the efficiency of the cleaning by wiping is increased by the presence of vacuum enhanced by the action of sealing. The efficiency of the cleaning by vacuum sealing is increased by the wiping action. This synergistic effect goes beyond the sum of the effects of cleaning with a sealing action or a wiping action, respectively, since a dirty element which passes through the cleaning method will have its resistance to the wiping action greatly decreased when a suction action with a sealing effect is performed, and will have its resistance to the suction action greatly decreased when a wiping action is implemented with the same contact cleaning element.

In terms of the present invention, the term “perpendicular” embraces not only angles of 90° but also angles between 90°+/−5°.

In terms of the present invention, the term “parallel” embraces not only angles of 180° but also angles between 180°+/−5°.

The contact cleaning element may be a rubbing element which may be configured to wipe the nozzle plate when the contact cleaning element contacts the nozzle plate and the main body is moved with respect to the print head body along the second direction.

Such a rubbing element allows performing a wiping of the nozzle plate, which further increases efficiency of the cleaning process by the suction hole.

The second direction may be perpendicular to a printing direction which may be a direction of processing of a card by the drop-on-demand print head.

Such a configuration is particularly well-adapted for a printing system including a relatively high number of print heads, such as a colour printing system.

The second direction may be parallel to a printing direction which may be a direction of processing of a card by the drop-on-demand print head.

Such an arrangement is particularly well-adapted for a printing system including a relatively low number of print heads, such as one, two or three print head(s), such as in a monochrome printing system.

The spraying means may include a cleaning fluid nozzle. The cleaning fluid nozzle may be centrally mounted with respect to the suction hole. The cleaning fluid nozzle may be a flat jet nozzle.

Such a configuration allows implementing a homogenous distribution of a cleaning fluid on the nozzles distributed on the nozzle plate, which optimizes the cleaning of the print head and the wetting of the sealing wiper formed by the contact cleaning element.

One may also foresee an additional suction hole. The suction passage may fluidly communicate with the additional suction hole.

The outer surface of the main body may further comprise an additional contact cleaning element. The additional contact cleaning element may surround at least in part an outer perimeter of the additional suction hole.

The plurality of nozzles may be distributed in two pairs of longitudinal rows of nozzles. Each of the suction hole and additional suction hole may be respectively associated with a pair of nozzle rows.

Such an arrangement allows associating a suction hole or an additional suction hole and a contact cleaning element or an additional contact cleaning element with, respectively, the two pairs of the nozzle rows. This allows making a particularly efficient use of the vacuum provided by the suction hole and the additional suction hole in order to clean or wipe more efficiently the nozzles distributed on the nozzle plate.

A distance between a centre of gravity of the suction hole and a centre of gravity of the additional suction hole may be smaller than 20 mm and higher than 5 mm, preferably smaller than 18 mm and higher than 6 mm.

Such an arrangement makes the cleaning assembly particularly adapted to a print head in which the nozzles are distributed on the nozzle plate in two pairs of longitudinal rows of nozzles, which is an advantageous distribution for a print head of a printing system forming part of a card processing system.

A ratio of an average distance between the points of a central line of the contact cleaning element and a centre of gravity of the suction hole, over a distance between the centre of gravity of the suction hole and the point of the perimeter of the suction hole being closest to the centre of gravity, may be smaller than 50 and higher than 1, preferably smaller than 42 and/or higher than 2, more preferably higher than 5, even more preferably smaller than 30 and higher than 6.25.

Such a ratio allows having the contact cleaning element closely associated with an outer perimeter of the suction hole, which maximizes the increase of efficiency due to the cleaning by contact in combination with a suction hole.

The suction hole may be provided on the outer surface.

A distance between a centre of gravity of the suction hole and a point of the outer perimeter of the suction hole being closest to the centre of gravity may be higher than 1.4 mm, preferably higher than 1.7 mm, more preferably higher than 2 mm.

This makes it possible to have a relatively big suction hole, resulting in avoiding as much as possible polymerization of ink contained in the suction hole, which would otherwise clog the suction hole. Therefore, efficiency of the cleaning of the nozzles is increased.

The contact cleaning element may be annular. The contact cleaning element may be closed on itself.

Having a contact cleaning element being annular or closed on itself allows using two surfaces of the contact cleaning element for wiping a surface near the nozzles, which makes it possible to further increase efficiency of the cleaning due to a cleaning by contact combined with a suction hole.

The suction hole may be circular in axial cross-section. The contact cleaning element may be circular in axial cross-section.

The suction hole and the contact cleaning element may be concentric.

Such geometrical features of the suction hole and the contact cleaning element allow adapting particularly well the contact cleaning element so that it cooperates with one associated suction hole. This allows optimizing the cleaning by contact combined with one suction hole.

The suction hole may be elongated in axial cross-section. The contact cleaning element may be elongated in axial cross-section.

A width of the elongated contact cleaning element may be smaller than 15 mm and higher than 5 mm, preferably smaller than 12.5 mm and higher than 6.5 mm.

A length of the elongated contact cleaning element may be smaller than 35 mm and higher than 10 mm, preferably smaller than 29 mm and higher than 15 mm.

Such dimensions and/or geometrical features of the suction hole and the contact cleaning element allow having a contact cleaning element adapted to cooperate with more than one suction hole, such as a contact cleaning element surrounding two suction holes. This allows optimizing the cleaning by contact combined with suction holes without making it necessary to have more than one contact cleaning element.

As an alternative, the contact cleaning element may have a “C” shape.

Indeed, a partial sealing may be obtained even in a case of a contact cleaning element being not annular or closed on itself, such as a contact cleaning element having a “C” shape. Furthermore, the contact cleaning element being not closed on itself may be compressed when brought in contact against the nozzle plate, in such a way that the two circumferential ends of the contact cleaning element are brought in contact with each other when the contact cleaning element is compressed and a sealing may be obtained due to this further contact of the two circumferential ends with each other. Furthermore, a wiping effect may be obtained even in the absence of an annular or closed-on-itself contact cleaning element.

One may also foresee a spring-loaded connection arrangement. The main body may be mechanically connected to a support member via the spring-loaded connection arrangement.

Such an arrangement allows providing a defined force against the nozzle plate, which results in ensuring sufficient vacuum while mitigating an amount of possible damage to the nozzle plate.

A ratio of an area of a region surface delimited by the contact cleaning element over an area of the outer surface may be smaller than ½ and higher than 1/13.

A perimeter of the suction hole may be higher than 7 mm and/or lower than 60 mm, preferably between 25 mm and 60 mm.

An area of the suction hole may be higher than 3.9 mm² and/or lower than 120 mm², preferably between 30 mm² and 120 mm².

According to a second aspect of the present disclosure, there is provided a cleaning method.

The cleaning method may involve the cleaning assembly as set forth above.

The cleaning method may be a cleaning method of a drop-on-demand print head having a print head body, a nozzle plate and a plurality of nozzles distributed on a nozzle plate. The cleaning method may include a step of positioning a main body of a cleaning assembly with respect to the print head body. The step of positioning may be implemented so that an outer surface of the main body may face at least a part of the nozzle plate. The step of positioning may be implemented so that a suction hole provided near the outer surface may face at least one of the plurality of nozzles. The cleaning method may include a step of moving the main body with respect to the print head body. The step of moving the main body may be performed along a first direction which may be perpendicular to a plane of the nozzle plate. In the step of moving, a contact cleaning element may be provided on the outer surface of the main body, may surround at least in part an outer perimeter of the suction hole and may be brought in contact with the nozzle plate. The cleaning method may include, after the step of moving, a step of sealing. In the step of sealing, a vacuum may be applied to the suction hole. The cleaning method may include, after the step of moving, a step of rubbing. In the step of rubbing, the main body may be moved relative to the print head body along a second direction which may be parallel to the plane of the nozzle plate.

The cleaning method may include a step of spraying by means of cleaning fluid nozzles a cleaning fluid inside the suction hole towards an outside of the main body.

According to a third aspect of the present disclosure, there is provided a printing method including the cleaning method as set forth above.

According to a fourth aspect of the present disclosure, there is provided a processing method including the printing method and/or the cleaning method as set forth above.

The processing method may be a card processing method. According to a fifth aspect of the present disclosure, there is provided a cleaning method.

The cleaning method may involve the cleaning assembly as set forth above.

### BRIEF DESCRIPTION OF DRAWINGS

To enable better understanding of the present disclosure, and to show how the same may be carried into effect, reference will now be made, by way of examples only, to the accompanying schematic drawings, in which:

FIG. 1 shows a schematic view of a card processing system according to one or more embodiments shown and described herein;

FIG. 2 is an isometric view of four sets forming part of the processing system of FIG. 1;

FIG. 3 is an isometric view of a set and a print head of the card processing system of FIG. 1;

FIG. 4A is a bottom view of a nozzle plate of the print head of FIG. 3;

FIG. 4B is an enlarged view of a part of a pair of nozzle rows of a nozzle plate depicted in FIG. 4A;

FIG. 5 is an isometric view of a cleaning assembly forming part of one of the sets depicted in FIGS. 2 and 3;

FIG. 6 is a top view of the cleaning assembly of FIG. 5;

FIG. 7 is an isometric view of a cleaning assembly according to one or more embodiments shown and described herein;

FIG. 8 is an isometric view of a cleaning assembly according to one or more embodiments shown and described herein;

FIG. 9 is a cross-sectional view of the cleaning assembly of FIG. 8;

FIG. 10 is a schematic view of a cleaning fluid nozzle forming part of the cleaning assembly of FIGS. 8 and 9;

FIG. 11 is a bottom view of nozzle plates of a printing system according to one or more embodiments shown and described herein;

FIG. 12 is an isometric view of a cleaning assembly according to one or more embodiments shown and described herein, which may be particularly well-associated with a system such as the one of FIG. 11;

FIG. 13 is a cross-sectional view of a cleaning assembly according to one or more embodiments shown and described herein;

FIG. 14 is a cross-sectional view of a cleaning assembly according to one or more embodiments shown and described herein;

FIG. 15 is a flow chart of a processing method according to one or more embodiments shown and described herein;

FIG. 16 is a flow chart of a printing phase of the processing method of FIG. 15; and

FIG. 17 is a flow chart of a cleaning phase of the processing method of FIG. 15.

### DESCRIPTION OF EMBODIMENTS

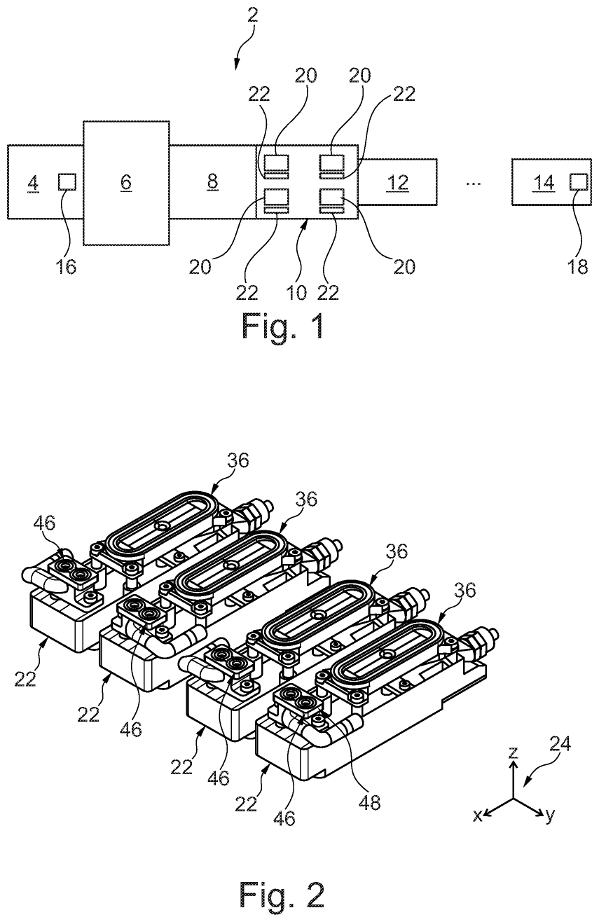

According to the present disclosure, FIG. 1 shows a processing system 2. The processing system 2 may be a card processing system. Such a system may be configured to process cards which may be plastic cards including, but not limited to, financial cards, credit cards, debit cards, driver's licenses, national identification cards, business identification cards, gift cards and other plastic cards. Alternatively, cards may also be paper cards, metal cards or hybrid material (for example metal and plastics) cards, and may have surfaces including plastic material.

The processing system 2 may include a card input 4, a magnetic stripe read and/or write system 6, a chip programming system 8, a drop-on-demand (DOD) card printing system 10, an ultraviolet (UV) cure station 12 and a card output 14. By virtue of the processing system 2, a card substrate 16 may be processed by the processing system 2, and in particular a printing operation may be implemented on the card substrate 16 by virtue of the DOD card printing system 10, in order to obtain a processed card 18.

As it is visible in FIGS. 1, 2 and 3, the DOD card printing system 10 includes four DOD print heads 20 respectively associated with four sets 22. The DOD print head 20 performs a printing operation on the card substrate 16. The ink used by the DOD print head 20 is, in the depicted embodiment, a UV curable ink. As an alternative, the ink can be a LED curable ink or a water-based ink.

An orthonormal vector basis 24 is associated with the sets 22. The orthonormal vector basis 24 is composed of a vector X, of a vector Y and of a vector Z. Unless provided otherwise, for the present description, the direction of the vector Z is considered to be a vertical direction, in which the vector Z is vertically, upwards directed.

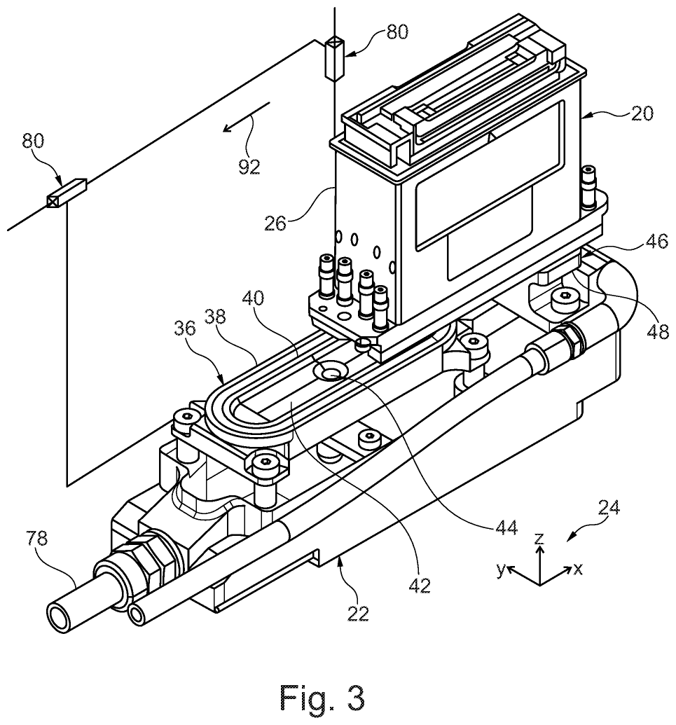

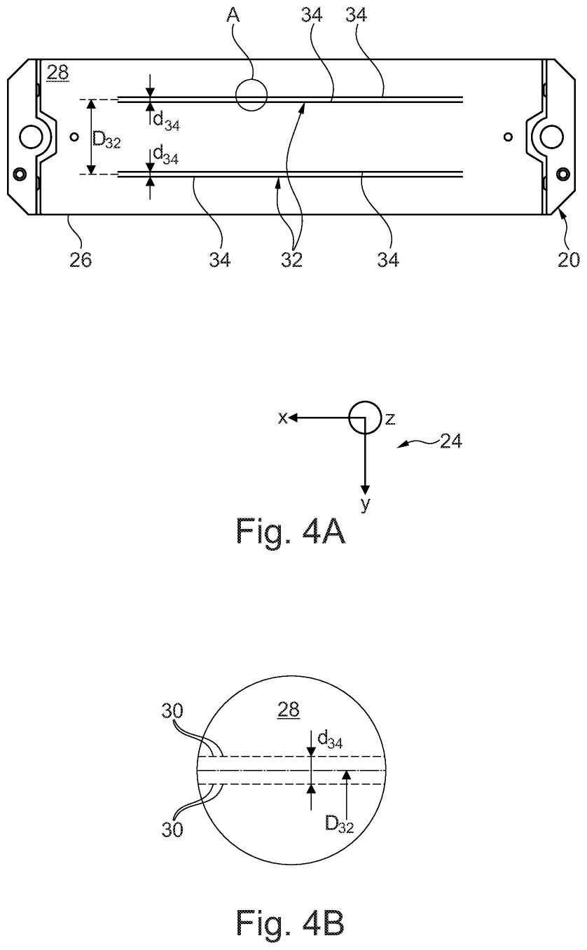

Referring to FIGS. 3 and 4, the print head 20 comprises a print head body 26 comprising a lower surface 28 forming a nozzle plate. In the depicted embodiment, the nozzle plate formed by the lower surface 28 is plane. Furthermore, the nozzle plate formed by the lower surface 28 is perpendicular to the direction of the vector Z.

A plurality of nozzles 30, e.g. 1024 nozzles 30, are distributed on the nozzle plate 28. More specifically, as visible in FIGS. 4A and 4B, the plurality of nozzles 30 are distributed in two pairs 32 of nozzle rows 34. The nozzle rows 34 extend along the direction of the vector X. A distance d34 between two nozzle rows 34 of a same pair of nozzle rows 32 may be smaller than 1.6 mm and/or higher than 0.3 mm. A distance D32 between the two pairs 32 of nozzle rows, which corresponds to a distance between a first axis parallel to the nozzle rows 34 and extending centrally between the nozzle rows 34 of a first pair of nozzle rows 32, and a second axis extending parallel to the nozzle rows 34 centrally between the nozzle rows 34 of a second pair of nozzle rows 32, may be smaller than 18 mm and higher than 9 mm.

Referring back to FIGS. 2 and 3, the set 22 includes a capping assembly 36. The capping assembly 36 includes a plurality of elastomeric seals 38, 40 intended to face the nozzle plate 28 when the print head 20 is in a capped position. The capping assembly 36 also includes a collecting chamber 42 provided with a collecting passage 44 for collecting any fluid from the nozzle plate 28 when the print head 20 is in the capped position.

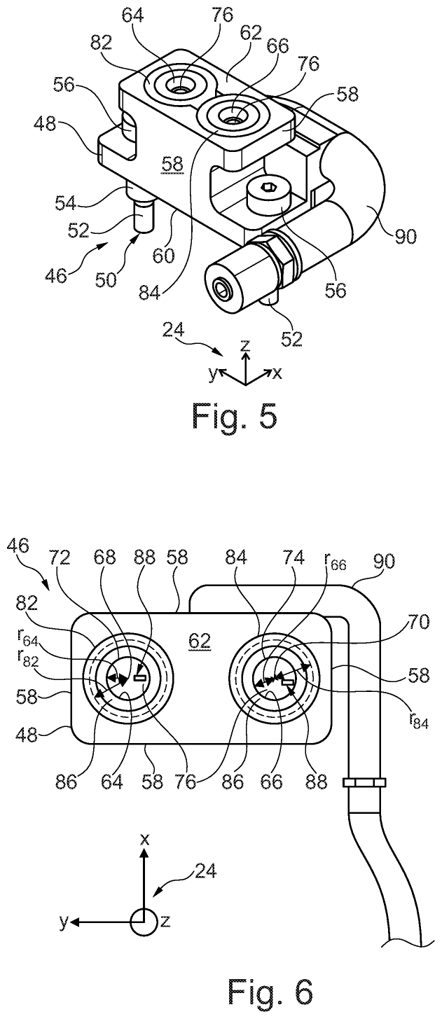

Each set 22 includes a cleaning assembly 46. The cleaning assembly 46 is shown in the respective isometric and top view of FIGS. 5 and 6 without the capping assembly 36. The cleaning assembly 46 is intended to clean the print head 20 associated therewith, before capping of the print head 20 by the capping assembly 36.

The cleaning assembly 46 includes a main body 48. The main body 48 is aligned, along the direction of the vector X, with respect to the capping assembly 36.

The cleaning assembly 46 includes a spring-loaded connection arrangement 50. The main body 48 is mechanically connected to the set 22 via the spring-loaded connection arrangement 50. Without departing from the scope of the invention, the main body 48 may be mechanically connected, via the spring-loaded connection arrangement 50, to any other support member.

As visible in FIG. 5, the spring-loaded connection arrangement 50 includes a sliding rod 52 intended to be received in a corresponding bore of the set 22, and a compression spring 54 which may generate an elastic force pushing the main body 48 vertically upwards with respect to the set 22.

In the depicted embodiment, the spring-loaded connection arrangement 50 further includes two adjustment screws 56 which may adjust a state of compression of the compression spring 54.

The main body 48 includes a plurality of outer surfaces, including in particular four side surfaces 58, a bottom outer surface 60 and a top outer surface 62. In the depicted embodiment, the top outer surface 62 is plane. Furthermore, the top outer surface 62 is perpendicular to the direction of the vector Z. By virtue of this arrangement, the top outer surface 62 is configured to face the nozzle plate 28. In particular, for any point of the top outer surface 62, there is a moment at which the point of the outer surface 62 faces the nozzle plate 28. In the depicted embodiment, at a given moment, all points of the top outer surface 62 face the nozzle plate 28.

The cleaning assembly 46 includes two suction holes 64 and 66 delimited by respective parameters 72, 74. The suction holes 64 and 66 are provided on the top outer surface 62. In an axial cross-section perpendicular to the direction of the vector Z, the suction holes 64 and 66 are circular around respective centres 68, 70. The suction holes 64 and 66 are aligned with respect to each other along the direction of the vector Y. By virtue of this arrangement, when the top outer surface 62 faces at least a part of the nozzle plate 28, the suction holes 64 and 66 may face at least one of the plurality of nozzles 30.

In the depicted embodiment, and as shown in FIG. 6, a radius r64, r66 of the respective suction holes 64 and 66 is higher than 1 mm. Nevertheless, in case one of the suction holes 64 and/or 66 has an axial cross-section perpendicular to the direction of the vector Z different from a circular axial cross-section, the radii r64, r66 may be replaced with a distance between the centre of gravity 68, 70 of the respective suction hole 64, 66 and the point of the perimeter 72, 74 which is closest to the centre of gravity 68, 70. The radii R64 and R66 may be equal to each other, and may be equal to the distance d34+/−5%.

In the depicted embodiment, a perimeter, or a length of the perimeter 72, 74 of the respective suction hole 64, 66 is higher than 7 mm and/or lower than 12 mm. Furthermore, an area of the axial cross-section, along the direction of the vector X, of the suction hole 64, 66, which corresponds to an area delimited by the respective perimeter 72, 74, is higher than 3.9 mm² and/or lower than 11.5 mm².

In the depicted embodiment, the distance between the centres of gravity 68, 70 of the respective suction holes 64, 66 equals the distance D32+/−5%. By virtue of this arrangement, each of the suction holes 64, 66 is respectively associated with a pair of nozzle rows 32.

The cleaning assembly 46 includes a suction passage 76. The suction passage 76 extends through the main body 48. The suction passage 76 fluidly communicates with the suction holes 64 and 66. The suction passage 76 fluidly communicates with a suction hose 78 (see FIG. 3) fluidly connected to a vacuum pump (not depicted).

The cleaning assembly 46 further includes a moving mechanism 80. The moving mechanism 80 mechanically connects the main body 48 to the print head body 26. In the depicted embodiment, the moving mechanism 80 indirectly mechanically connects the main body 48 to the print head body 26, by directly mechanically connecting the set 22 to the print head body 26. However, it may be contemplated, without going beyond the scope of the present invention, to have a moving mechanism directly connecting the main body 48 with the print head body 26. The moving mechanism 80 allows moving the main body 48 with respect to the print head body 26 along the direction of the vector X and along the direction of the vector Z.

The cleaning assembly 46 includes two contact cleaning elements 82, 84. The contact cleaning elements 82 and 84 are respectively associated with the suction holes 64, 66. More in detail, the contact cleaning elements 82, 84 respectively surround an outer circumference of the suction holes 64, 66. In the depicted embodiment, the contact cleaning elements 82, 84 are annular. As visible in FIG. 6, the contact cleaning elements 82, 84 are closed on themselves. In more detail, the contact cleaning elements 82, 84 are concentric with the respective suction holes 64, 66. In other words, a centre of a circular axial cross-section of the respective contact cleaning element 82, 84 is, respectively, the centre of gravity 68 and 70. Therefore, the contact cleaning elements 82, 84 are provided along the circumference of the respective suction holes 64, 66.

In case a suction hole 64, 66 does not have a circular axial cross-section, the associated contact cleaning element 82, 84 may be provided on or along a perimeter of the suction hole 64 or 66. In case the contact cleaning element 82, 84 is not closed on itself, the contact cleaning element 82 or 84 may be provided on or along at least a part of the perimeter of the associated suction hole 64 or 66.

The contact cleaning elements 82, 84 include an elastomeric material. The elastomeric material includes at least one of natural rubber, synthetic rubber, styrene-butadiene rubber.

The moving mechanism 80 is therefore able to bring the contact cleaning elements 82, 84 in contact with the nozzle plate 28. Furthermore, the moving mechanism 80 is able to move the main body 48 relative to the print head body 26 along the direction of the vector X when the contact cleaning elements 82, 84 contact the nozzle plate 28.

By virtue of such an arrangement, the contact cleaning elements 82, 84 may act as sealing elements. In other words, the contact cleaning elements 82, 84 may seal a volume fluidly communicating with the respective suction holes 64, 66 when the contact cleaning elements 82, 84 contact the nozzle plate. This results in the possibility of having a relatively big suction hole, resulting in avoiding polymerization of ink contained in the suction hole 64 or 66.

An area of a region surface 86 delimited by the contact cleaning elements 82, 84 is smaller than an area of the outer surface 62:

A86=A82+A84<A62

wherein A62 is the area of the outer surface 62, A82 is the area of a region surface delimited by the elongated contact cleaning element 82, A84 is the area of a region surface delimited by the elongated contact cleaning element 84, and A86 is the area of a region surface delimited by the elongated contact cleaning elements 82 and 84, that is, the sum of the areas A82 and A84.

In more detail, a ratio of the area A86 of the region surface 86 over the area A62 of the outer surface 62 is smaller than ½ and higher than 1/13:

1/13<A86/A62<½.

Furthermore, in the depicted embodiment, a ratio of a radius r82 or r84 of a circular central line of the respective contact cleaning elements 82, 84, over the respective radius r64 or r66, is smaller than 5 and higher than 2:

2<r82/r64<5;

2<r84/r66<5.

In the depicted embodiment, since the contact cleaning elements 82, 84 are respectively concentric with the suction holes 64 and 66, the radius r82 is the distance between the centre of gravity 68 and any point of the circular central line of the contact cleaning element 82 and the radius r84 is the distance between the centre of gravity 70 and any point of the circular central line of the contact cleaning element 84. In a case where the contact cleaning element 82, 84 and the associated suction hole 64, 66 are not concentric with each other, or in a case where the contact cleaning element 82, 84 and/or the suction hole 64, 66 associated therewith is not circular in axial cross-section, the ratio of an average distance between the points of a central line of the contact cleaning elements 82, 84 and a centre of gravity 68, 70 of the associated respective suction hole 64, 66 over a distance between the centre of gravity 68, 70 of the suction hole 64, 66 and the point of the perimeter 72, 74 being closest to the respective centre of gravity 68, 70 is smaller than 5 and higher than 1.

The contact cleaning elements 82, 84 may therefore act as rubbing elements. The contact cleaning elements 82, 84 are able to wipe the nozzle plate 28 when they contact the nozzle plate 28 and when the main body 48 is moved with respect to the print head body 26 along the direction of the vector X.

By virtue of this arrangement, there is provided a cleaning by contact, in particular with a wiping of the nozzle plate, in combination with a suction hole which results in a more efficient cleaning of the nozzles.

Having a contact cleaning element 82, 84 being annular and/or closed on itself is not mandatory to achieve the technical effect of increasing efficiency of cleaning due to a cleaning by contact combined with a suction hole. In particular, a partial sealing may be obtained even in a case of a contact cleaning element 82, 84 being not closed on itself, such as a contact cleaning element 82, 84 having a shape of a C. Furthermore, the contact cleaning element 82, 84 being not closed on itself may be compressed when brought in contact against the nozzle plate 28, in such a way that the two circumferential ends of the contact cleaning element 82, 84 are brought in contact with each other when the contact cleaning element 82, 84 is compressed and a sealing may be obtained due to this further contact of the two circumferential ends with each other. Furthermore, a wiping effect may be obtained even in the absence of an annular or closed-on-itself contact cleaning element.

Referring to FIG. 6, the cleaning assembly 46 includes two cleaning fluid nozzles 88. The cleaning fluid nozzles 88 are respectively associated with the suction holes 64 and 66. More in detail, the cleaning fluid nozzles 88 are centrally mounted with respect to each of the respective suction holes 64 and 66. The cleaning fluid nozzles 88 are flat jet nozzles.

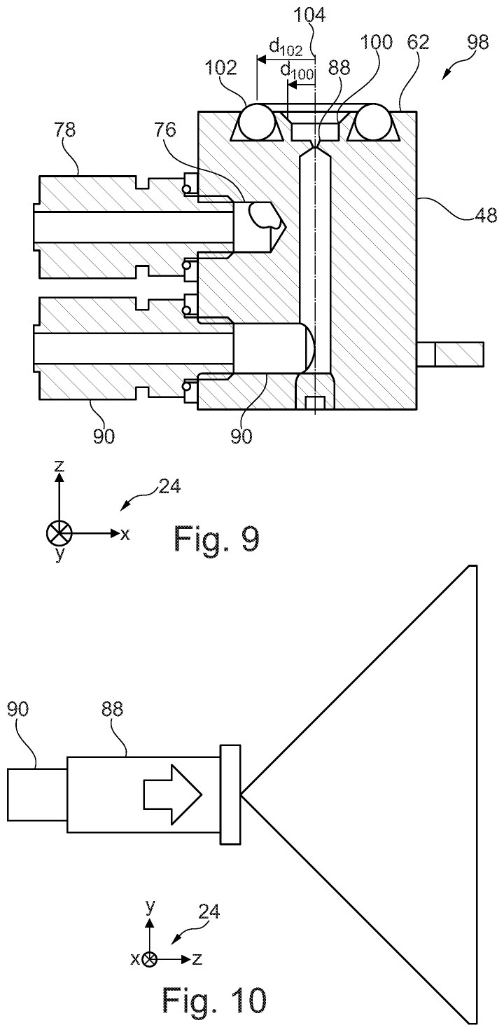

The cleaning assembly 46 further includes a cleaning fluid passage 90. The cleaning fluid passage 90 may include a first section consisting of a cleaning fluid hose located outside the main body 48 (visible in FIGS. 3, 5 and 6) and an inner portion extending through the main body 48 (not visible in the figures for this embodiment, visible in FIG. 9 for another embodiment). By virtue of this arrangement, the cleaning fluid passage 90 may fluidly communicate with each of the suction holes 64 and 66. In more detail, the cleaning fluid passage 90 fluidly communicates with the respective cleaning fluid nozzles 88. Therefore, the cleaning fluid passage 90 provides a cleaning fluid to the cleaning fluid nozzles 88. In turn, the cleaning fluid nozzles 88 may spray the cleaning fluid inside the respective suction hole 66, 64 towards an outside of the main body 48. The cleaning fluid may include a lubricant. In addition or as an alternative, the cleaning fluid may include the ink of the DOD print head 20.

With respect to FIGS. 2 and 3, in the present embodiment, which corresponds to a colour printing system having a plurality of print heads 20, the printing direction, which corresponds to a direction of transport of a card substrate 16 with respect to the sets 22, is parallel to the vector Y. Therefore, in the depicted embodiment, the direction 92 (visible in FIG. 3) in which the main body 48 is moved by the moving mechanism 80 with respect to the print head body 26 when the contact cleaning elements 82, 84 contact the nozzle plate 28 is perpendicular to the printing direction.

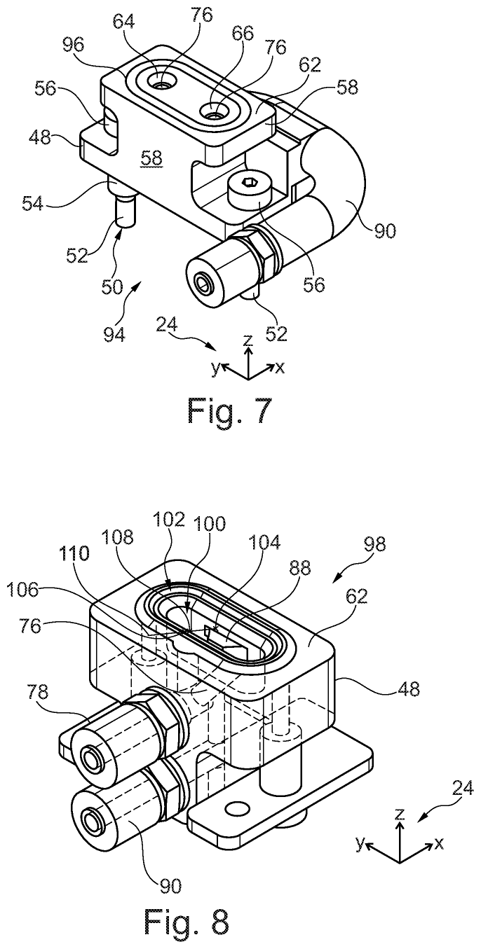

FIG. 7 shows a cleaning assembly 94 according to one or more embodiments disclosed herein. The cleaning assembly 94 differs from the cleaning assembly 46 by a different geometry and a different number of the contact cleaning element. Namely, instead of the two contact cleaning elements 82, 84, the cleaning assembly 94 includes a single contact cleaning element 96. As visible in FIG. 7, the contact cleaning element 96 is elongated. In more detail, the contact cleaning element 96 includes two ends having a semicircular axial cross-section perpendicular to the direction of the vector Z, and a central, rectilinear portion parallel to the vector Y and connecting the two semicircular ends to each other.

In the depicted embodiment, the same contact cleaning element 96 surrounds at least a part of the first suction hole 64 and at least a part of the second suction hole 66.

In the depicted embodiment, the radius of the semicircular ends of elongated contact cleaning element 96 is the same as the radius r82 or r84 of the contact cleaning element 82 or 84 of the cleaning assembly 46.

In the depicted embodiment, a width w96 of the elongated contact cleaning element 96, taken along in a plane of symmetry of the contact cleaning element 96 perpendicular to the direction of the vector X, is smaller than 13 mm and higher than 7 mm:

7 mm<w96<13 mm.

In the depicted embodiment, a length l96 of the elongated contact cleaning element 96, taken along in a plane of symmetry of the contact cleaning element 96 perpendicular to the direction of the vector Y, is smaller than 27 mm and higher than 17 mm:

17 mm<l96<27 mm.

FIGS. 8 and 9 show a cleaning assembly 98 according to one or more embodiments disclosed herein. The cleaning assembly 98 differs from the cleaning assembly 46 by the number and shape of suction holes and by the number and shape of contact cleaning elements. In detail, the cleaning assembly 98 includes a single, elongated suction hole 100. The suction hole 100 extends along the direction of the vector Y. The suction hole 100 includes a cleaning fluid nozzle 88 centrally located, along the direction of the vector Y, with respect to the suction hole 100. The suction hole 100 includes two longitudinal ends having a semicircular cross-section with respective radii corresponding to the radii r64 and r66. The longitudinal ends of the suction hole 100 are joined by a rectilinear portion parallel to the direction of the vector Y.

The cleaning assembly 98 includes a single, elongated contact cleaning element 102. The contact cleaning element 102 has the same shape as the contact cleaning element 96 of the cleaning assembly 94. In other words, the contact cleaning element 102 is provided on the perimeter of the suction hole 100. In the present embodiment, the suction hole 100 faces the nozzles 30 of both pairs of nozzle rows 32 and the contact cleaning element 102 seals a space wherein the nozzles 30 of both pairs of nozzles 32 are contained.

By virtue of this arrangement, it is possible to have an even bigger dimension of the suction hole 100. In more detail, for any first point 106 of a central line of the contact cleaning element 102, a ratio of a distance d102 between the first point 106 and a centre of gravity 104 of the suction hole 100, over a distance d100 between a second point 108 on the perimeter of the suction hole 100 and the centre of gravity 104 is smaller than 6 and higher than 3, wherein the first point 106, the second point 108 and the centre of gravity 104 are provided on a same line 110:

3<d102/d100<6

In the embodiments with an elongated suction hole, such as the embodiment of FIGS. 8 and 9, the perimeter of the suction hole 100 is preferably between 25 mm and 60 mm and the area of the suction hole 100 is preferably between 30 mm² and 120 mm².

Referring now to FIG. 10, a spray of cleaning fluid generated by the cleaning fluid nozzle 88 is schematically depicted. As visible in FIG. 10, the cleaning fluid nozzle 88 is fed with a cleaning fluid by the cleaning fluid passage 90. Then, the cleaning fluid nozzle 88 is able to spray cleaning fluid towards the direction of the vector Z. Furthermore, as depicted in FIG. 10, the flat jet cleaning fluid nozzle 88 generates a flat jet cleaning fluid spray included in the plane perpendicular to the vector X. Therefore, a homogenous distribution of the cleaning fluid is made possible on the nozzle plate 28.

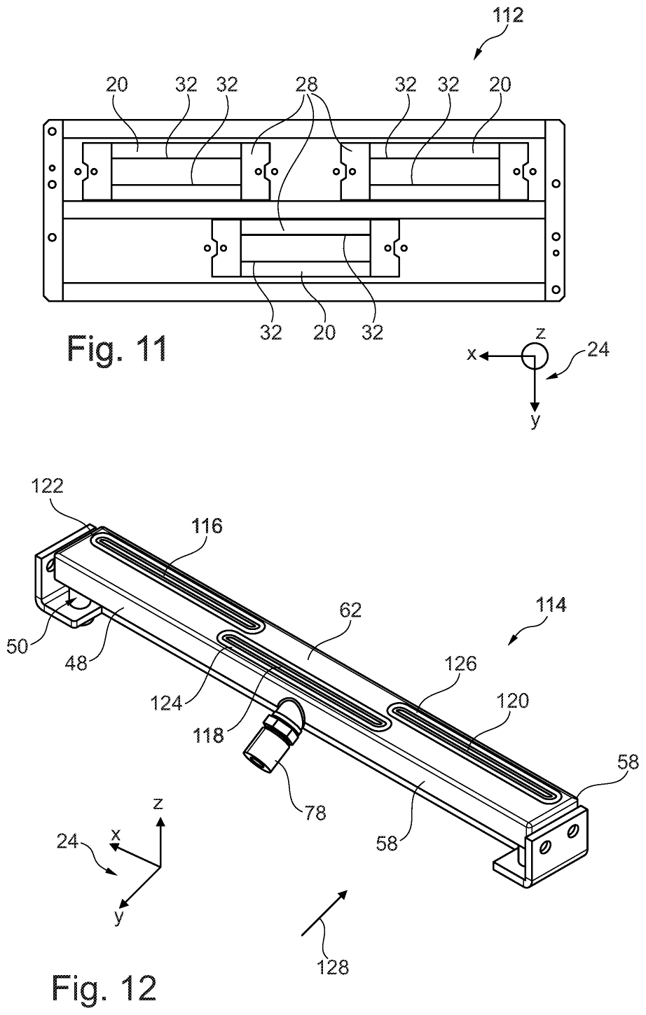

Referring now to FIGS. 11 and 12, a printing system 112 and an associated cleaning assembly 114 according to one or more embodiments disclosed herein are respectively depicted.

In the present embodiment, the printing direction, which is a direction of a passage of a card substrate being printed by the printing system 112, is parallel to the vector Y.

The printing system 112 differs from the printing system 10 of FIG. 1 by the number and arrangement of the DOD print heads 20. Namely, in the present embodiment, three DOD print heads 20 are provided in two respective lines parallel to the direction of the vector X, a first line including two DOD print heads 20 and a second line including one DOD print head 20. For each DOD print head 20, a first pair of nozzle rows 32 is able to eject ink of a first colour whereas a second pair of nozzle rows 32 is able to eject ink of a second colour. For example, the first colour is white, and the second colour is black. In other words, the printing system 112 is a monochrome printing system.

Referring now to FIG. 12, the cleaning assembly 114 includes three suction holes 116, 118 and 120 provided on the outer surface 62. The suction holes 116, 118 and 120 fluidly communicate with a suction passage (not depicted) extending through the main body 48 and a suction hose 78. The suction holes 116, 118 and 120 are provided on two parallel lines extending along the direction of the vector X, the suction holes 116 and 120 being provided on the same, first line and the suction hole 118 being provided on the second line. By virtue of this arrangement, the suction holes 116, 118 and 120 may be respectively associated with the print heads 20 taken in the direction opposite to the vector X.

The outer surface 62 further includes three elongated contact cleaning elements 122, 124 and 126. The elongated contact cleaning elements 122, 124 and 126 are respectively associated with the suction holes 116, 118 and 120. In detail, the contact cleaning elements 122, 124 and 126 respectively surround an outer perimeter of the suction holes 116, 118 and 120. Furthermore, an area of a region surface delimited by the respective elongated contact cleaning element 122, 124 and 126 is smaller than an area of the outer surface 62:

A122+A124+A126<A62,

wherein A62 is the area of the outer surface 62, A122 is the area of a region surface delimited by the elongated contact cleaning element 122, A124 is the area of a region surface delimited by the elongated contact cleaning element 124, and A126 is the area of a region surface delimited by the elongated contact cleaning element 126.

By virtue of this arrangement, the main body 48 may be arranged in such a position, with respect to the printing system 112, that the outer surface 62 faces the nozzle plate 28 of the print heads 20 and the suction holes 116, 118 and 120 face at least one of the plurality of nozzles 30 of the respective, associated print heads 20. In such an arrangement, the elongated contact cleaning elements 122, 124 and 126 may be brought in contact with the nozzle plate 28 of the respective, associated print heads 20. When an elongated contact cleaning element 122, 124 or 126 contacts a nozzle plate 28, the main body 48 is moved relating to the printing system 112 along a direction 128 parallel to the vector Y.

Therefore, the direction in which the main body 48 is moved, with respect to the printing system 112 when the contact cleaning elements 122, 124 and 126 contact the nozzle plate, is parallel to the printing direction.

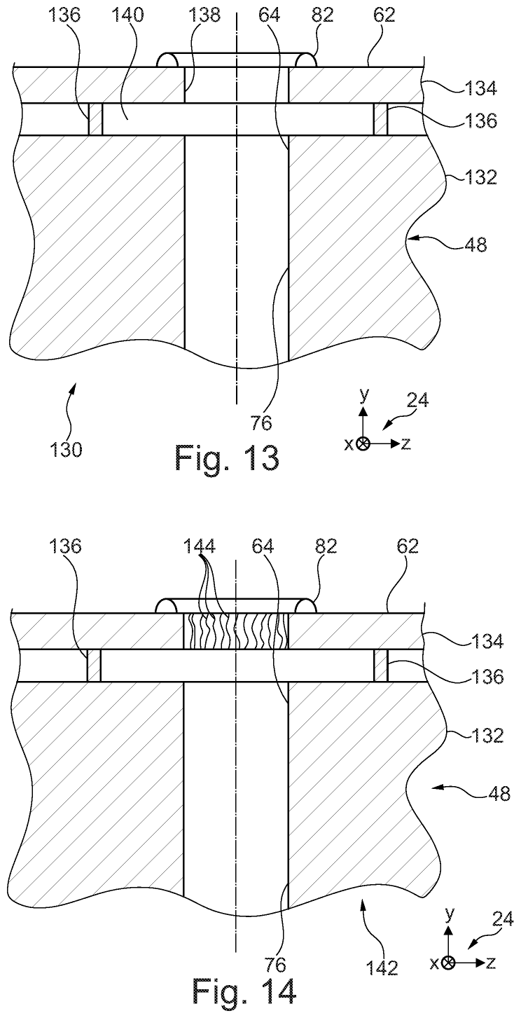

FIG. 13 shows a cross-sectional, enlarged view of a suction hole of a cleaning assembly 130 according to one or more embodiments disclosed herein. The cleaning assembly 130 differs from the cleaning assembly 46 in that the suction hole 64 is not provided on the outer surface 62 but near the outer surface 62.

In detail, in the present embodiment, the main body 48 includes a lower block 132, an upper plate 134 and a plurality of attachment rods 136. The lower block 132, the upper plate 134 and the attachment rods 136 are formed integral with each other. As a result, the upper plate 134 is mechanically attached to the lower block 132.

The upper plate 134 includes an additional through-hole 138 axially aligned with the suction hole 64. As well as in the embodiment of FIGS. 1 to 6, the contact cleaning element 82 is provided on the outer surface 62. In the present embodiment, the suction hole 64 is formed in the lower block 132 which does not include the outer surface 62. However, this embodiment allows achieving the wiping effect which is achieved by the cleaning assembly 46.

As a variant, the space 140 extending vertically between the upper plate 134 and the lower block 132 may be sealed with respect to an outside of the main body 48. In such a variant, the sealing effect which is obtained by virtue of the cleaning assembly 46 may also be obtained by the cleaning assembly 130.

FIG. 14 shows a cleaning assembly 142 according to one or more embodiments disclosed herein. The cleaning assembly 142 differs from the cleaning assembly 130 in that the upper plate 134 does not include an additional through-hole 138 but is porous. In more detail, a plurality of pores 144 are provided in the upper plate 134.

As well as the cleaning assembly 130, the cleaning assembly 142 allows taking advantage of the wiping effect and of the sealing effect which is achieved by the cleaning assembly 46 and which allows cleaning by contact in combination with a suction hole, therefore resulting in a more efficient cleaning of the nozzles.

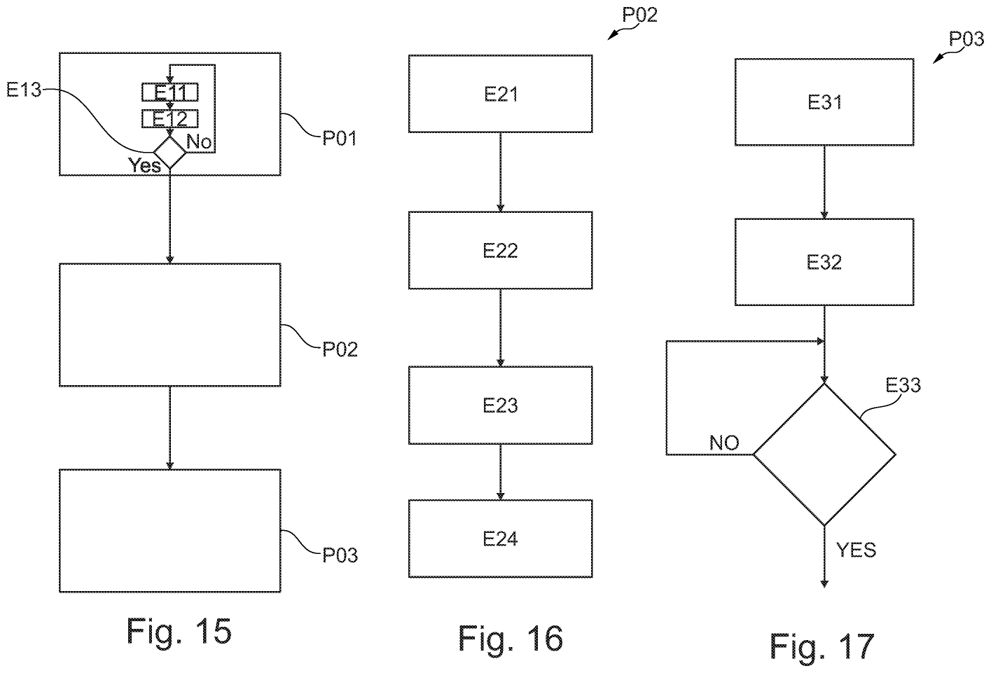

Referring now to FIGS. 15 to 17, it is shown a card processing method according to one or more embodiments disclosed herein. The card processing method depicted in FIGS. 15 to 17 may be implemented by means of the cleaning assembly 46, as it will be described later, or by means of any other cleaning assembly.

Referring to FIG. 15, the processing method includes, in this order, a printing phase P01, a cleaning phase P02 and a capping phase P03.

The printing phase P01 includes a first step E11 of moving a card substrate 16 along the printing direction under the DOD printing system 10. The printing phase P01 includes a second step E12 of ejecting ink by the DOD print heads 20 on the card substrate 16. By doing so, a DOD printing operation is implemented on the card substrate 16.

The printing phase P01 includes a test step E13 of detecting an end of the printing operation by the DOD printing system 10. As long as, during the test step E13, no order for an end of the printing operation is detected, the steps E11 and E12 are repeated. When an order for an end of the printing operation is detected in the test step E13, the printing phase P01 is ended and a cleaning phase P02 is initiated.

Referring now to FIG. 16, the cleaning phase P02 includes a first step E21 of positioning. During the step E21, the main body 48 is positioned with respect to the print head body 26, so that the outer surface 62 faces at least a part of the nozzle plate 28 and the suction holes 64, 66 face at least one of the nozzles 30 of the respective pairs of nozzle rows 32.

The cleaning phase P02 includes a second step E22 of moving the main body. During the step E22, the main body 48 is moved with respect to the print head body 26 along the direction of the vector Z. By doing so, the contact cleaning elements 82, 84 are brought in contact with the nozzle plate 28.

The cleaning phase P02 includes a third step E23 of sealing. During the step E23, a vacuum is applied to the suction holes 64 and 66. By doing so, the space delimited by the contact cleaning elements 82, 84 is sealed.

The cleaning phase P02 includes a fourth step E24 of rubbing. During the step E24, the main body 48 is moved relative to the print head body 26 along the direction of the vector X. By doing so, a wiping effect is obtained, in which the nozzles 30 are rubbed by the contact cleaning elements 82 and 84.

Referring to FIG. 17, the capping phase P03 includes a first step E31 of moving the print head body 26 with respect to the set 22 along a direction parallel to the vector X until a moment where the print head body 26 is vertically aligned with the elastomeric seals 38 and 40. Then, the capping phase P03 includes a second step E32 of moving the print head body 26 along a direction parallel to the vector Z until a moment where the print head body 26 rests on the elastomeric seals 38 and 40. The capping phase P03 then includes a third, test step E33 of detecting an order for resuming printing operation. As long as, during the test step E33, it is not detected an order for resuming printing operation, the test step E33 is repeated. If, during the test step E33, it is detected an order for resuming printing operation, the method depicted in FIG. 15 is initiated and the phase P01 is restarted.

In a variant exemplary card processing method, the steps E23 and E24 of the cleaning phase P02 may be provided in a reverse order. Also, the steps E23 and E24 may be performed at the same time.

In a further variant of the exemplary method, it may be detected an order for a cleaning of the DOD printing system 10 without that an end of the printing operation is requested. In such a variant, the cleaning phase P02 may then be implemented and may be immediately followed by the step E11, when the cleaning of the DOD printing system 10 is completed.

Furthermore, a need for a cleaning, or an order for an end of the printing operation may be detected for only one of the print heads of the DOD printing system 10.

The following paragraphs, listed in alphanumeric order for reference, are non-limiting example modes of describing the invention.
A1. A cleaning assembly for a drop-on-demand print head having a print head body, a nozzle plate and a plurality of nozzles distributed on the nozzle plate, the cleaning assembly including:
a main body,
at least one suction hole provided near an outer surface of the main body, the main body being configured so that, when the cleaning assembly is used for cleaning a drop-on-demand print head, the suction hole is able to face at least one of the plurality of nozzles,
a suction passage fluidly communicating with the suction hole, and
a moving mechanism for moving the main body with respect to the print head body along a first direction perpendicular to a plane of the nozzle plate and along a second direction parallel to the plane of the nozzle plate,
   the outer surface of the main body including a contact cleaning element surrounding at least in part an outer perimeter of the suction hole, the moving mechanism being configured to bring the contact cleaning element in contact with the nozzle plate and further configured so that, when the contact cleaning element contacts the nozzle plate, it moves the main body relative to the print head body along the second direction, a distance between a centre of gravity of the suction hole and the point of the perimeter of the suction hole being closest to the centre of gravity being higher than 1.4 mm.
A2. The cleaning assembly according to paragraph A1, wherein the contact cleaning element is annular and/or closed on itself.
A3. The cleaning assembly according to claim paragraph A1 or A2, wherein the suction hole is circular in axial cross-section and the contact cleaning element is circular in axial cross-section.
A4. The cleaning assembly according to paragraph A3, wherein the suction hole and the contact cleaning element are concentric.
A5. The cleaning assembly according to paragraph A1 or A2, wherein the suction hole is elongated in axial cross-section.
A6. The cleaning assembly according to any one of paragraphs A1 to A5, wherein the contact cleaning element is elongated in axial cross-section.
A7. The cleaning assembly according to paragraph A6, wherein a width of the elongated contact cleaning element is smaller than 15 mm and/or higher than 5 mm and/or a length of the elongated contact cleaning element is smaller than 35 mm and/or higher than 10 mm.
A8. The cleaning assembly according to any one of paragraphs A1 to A7, further including a spring-loaded connection arrangement, the main body (48) being mechanically connected to a support member via the spring-loaded connection arrangement.
A9. The cleaning assembly according to any one of paragraphs A1 to A8, wherein a ratio of an average distance between the points of a central line of the contact cleaning element and a centre of gravity of the suction hole, over a distance between the centre of gravity of the suction hole and the point of the perimeter of the suction hole being closest to the centre of gravity, is smaller than 50 and/or higher than 1.
A10. The cleaning assembly according to any one of paragraphs A1 to A9, wherein a ratio of an area of a region surface delimited by the contact cleaning element over an area of the outer surface is smaller than ½ and/or higher than 1/13.
A11. The cleaning assembly according to any one of paragraphs A1 to A10, wherein a perimeter of the suction hole is higher than 7 mm and/or lower than 60 mm.
A12. The cleaning assembly according to any one of paragraphs A1 to A11, wherein an area of the suction hole is higher than 3.9 mm² and/or lower than 120 mm².
A13. A set comprising a capping assembly able to cap a plurality of nozzles distributed on a nozzle plate of a drop-on-demand print head and the cleaning assembly according to any one of paragraphs A1 to A12.
A14. A printing system comprising a drop-on-demand print head having a print head body, a nozzle plate and a plurality of nozzles distributed on the nozzle plate, and a set according to paragraph A13 and/or a cleaning assembly according to any one of paragraphs A1 to A12.

We claim:

1. A cleaning assembly for a drop-on-demand print head that has a print head body, a nozzle plate and a plurality of nozzles distributed on the nozzle plate, wherein the cleaning assembly comprises:
a main body;
at least one suction hole provided near an outer surface of the main body, wherein when the cleaning assembly is used for cleaning a drop-on-demand print head, the outer surface faces at least a part of the nozzle plate and the suction hole faces at least one of the plurality of nozzles;
a suction passage fluidly that communicates with the suction hole;
a moving mechanism that moves the main body with respect to the print head body along a first direction perpendicular to a plane of the nozzle plate and along a second direction parallel to the plane of the nozzle plate;
a cleaning fluid passage that communicates with the suction hole; and
a spraying device that fluidly communicates with the cleaning fluid passage so that it sprays a cleaning fluid inside the suction hole towards an outside of the main body,
wherein the outer surface of the main body includes a contact cleaning element that surrounds at least in part an outer perimeter of the suction hole, wherein an area of a region surface delimited by the contact cleaning element is smaller than an area of the outer surface, wherein the moving mechanism brings the contact cleaning element in contact with the nozzle plate and wherein, when the contact cleaning element contacts the nozzle plate, it moves the main body relative to the print head body along the second direction.

2. The cleaning assembly according to claim 1, wherein the contact cleaning element is a sealing element to seal a volume fluidly that communicates with the suction hole when the contact cleaning element contacts the nozzle plate.

3. The cleaning assembly according to claim 1, wherein the second direction is perpendicular to a printing direction that is a direction of processing of a card by the drop-on-demand print head.

4. The cleaning assembly according to claim 1, wherein the second direction is parallel to a printing direction that is a direction of processing of a card by the drop-on-demand print head.

5. The cleaning assembly according to claim 1, wherein the spraying device includes a cleaning fluid nozzle.

6. The cleaning assembly according to claim 1, further comprising an additional suction hole, wherein the suction passage fluidly communicates with the additional suction hole.

7. The cleaning assembly according to claim 6, wherein the outer surface of the main body further comprises an additional contact cleaning element that surrounds at least in part an outer perimeter of the additional suction hole and wherein, preferably, the plurality of nozzles are distributed in two pairs of longitudinal nozzle rows, wherein each of the suction hole and additional suction hole is respectively associated with a pair of nozzle rows.

8. The cleaning assembly according to claim 6, wherein a distance between a centre of gravity of the suction hole and a centre of gravity of the additional suction hole is smaller than 17.5 mm and higher than 6 mm.

9. The cleaning assembly according to claim 1, wherein a ratio of an average distance between the points of a central line of the contact cleaning element and a centre of gravity of the suction hole, over a distance between the centre of gravity of the suction hole and the point of the perimeter of the suction hole closest to the centre of gravity, is smaller than 50 and higher than 1.

10. The cleaning assembly according to claim 1, wherein the suction hole is provided on the outer surface.

11. A cleaning method that involves the cleaning assembly according to claim 1.

12. A cleaning method of a drop-on-demand print head that has a print head body, a nozzle plate and a plurality of nozzles distributed on the nozzle plate, wherein the cleaning method comprises:
a step of moving a main body of a cleaning assembly with respect to the print head body along a first direction perpendicular to a plane of the nozzle plate, in which step of moving a contact cleaning element that is provided on an outer surface of the main body and surrounds at least in part an outer perimeter of a suction hole provided near the outer surface is brought in contact with the nozzle plate;
after the step of moving, a step of sealing, in which step of sealing a vacuum is applied to the suction hole; and
after the step of moving, a step of rubbing, in which step of rubbing the main body is moved relative to the print head body along a second direction parallel to the plane of the nozzle plate,
wherein the cleaning method includes a step of spraying by means of cleaning fluid nozzles a cleaning fluid inside the suction hole towards an outside of the main body.

13. The cleaning method according to claim 12, further including a step of positioning the main body with respect to the print head body, so that the outer surface of the main body faces at least a part of the nozzle plate and a suction hole provided near the outer surface faces at least one of the plurality of nozzles.
